(19) United States
(12) Patent Application Publication
(10) Pub. No.: US 2011/0007150 A1
(43) Pub. Date: Jan. 13, 2011

(54) Extraction of Real World Positional Information from Video

(75) Inventors: Larry J. Johnson, Sachse, TX (US); Nicholas W. Knize, Rockwall, TX (US); Roberto (nmi) Reta, Richardson, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/501,905

(22) Filed: Jul. 13, 2009

(51) Int. Cl. H04N 7/18

(52) U.S. Cl. 348/135; 348/E07.085

(57) ABSTRACT

In accordance with a particular embodiment of the invention, a method includes receiving a data stream. The data stream includes a video stream. The video stream includes one or more video frames captured by a video camera. Each video frame presents an image of a real-world scene. The data stream also includes positional information of the video camera corresponding to the video stream. The positional information of the video camera may then be extracted from the data stream. The positional information of the video camera may be synchronized with the one or more video frames such that a two-dimensional point on the image corresponds to a three-dimensional location in the real world at the real-world scene.

### RELATED APPLICATIONS

This application is related to U.S. patent application Ser. No. ______, entitled “DISPLAYING SITUATIONAL INFORMATION BASED ON GEOSPATIAL DATA,” Attorney's Docket 064747.1328; to U.S. patent application Ser. No. ______, entitled “OVERLAY INFORMATION OVER VIDEO,” Attorney's Docket 064747.1329; and to U.S. patent application Ser. No. ______, entitled “SYNCHRONIZING VIDEO IMAGES AND THREE DIMENSIONAL VISUALIZATION IMAGES,” Attorney's Docket 064747.1330, all filed concurrently with the present application.

### TECHNICAL FIELD

The present disclosure relates generally to video streams, and more particularly to extraction of real world positional information from video.

### BACKGROUND

Videos may provide a viewer with information. These videos may capture scenes and events occurring at a particular location at a particular time. Video capture equipment may also log data related to the scenes and events, such as the location of the video capture equipment at the time the scenes and events were captured.

### SUMMARY OF EXAMPLE EMBODIMENTS

In accordance with a particular embodiment of the invention, a method includes receiving a data stream. The data stream includes a video stream. The video stream includes one or more video frames captured by a video camera. Each video frame presents an image of a real-world scene. The data stream also includes positional information of the video camera corresponding to the video stream. The positional information of the video camera may then be extracted from the data stream. The positional information of the video camera may be synchronized with the one or more video frames such that a two-dimensional point on the image corresponds to a three-dimensional location in the real world at the real-world scene.

Certain embodiments of the present invention may provide various technical advantages. A technical advantage of one embodiment may include the capability to use embedded metadata to extrapolate positional information about the video scene and targets captured within the video scene. Additionally, teachings of certain embodiments recognize that the metadata may be used to synchronize a video frame or a pixel within a video frame to a real-world position. Teachings of certain embodiments also recognize that mapping a pixel within a video frame to a real-world position may provide data regarding a scene or event captured within the video frame.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of certain embodiments of the present invention and features and advantages thereof, reference is now made to the following description taken in conjunction with the accompanying drawings, in which:

FIG. 1 shows an unmanned aerial vehicle (UAV) with video collection capabilities;

FIG. 2A shows one embodiment of a method for processing a video with embedded metadata;

FIG. 2B shows one example of a method for mapping pixels in a video frame to latitude/longitude information obtained from metadata; and

FIG. 3 presents an embodiment of a general purpose computer operable to perform one or more operations of various embodiments of the invention.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Videos may provide a viewer with information. However, the information provided by a video may be limited to the perspective of the device, such as a camera, that captures the video. However, some video collectors may embed additional information into the captured video. For example, some video collectors may embed geo-positional, target metadata, and other metadata into the video stream. Examples of geo-positional metadata may include, but are not limited to, latitude/longitude, altitude, azimuth, elevation, and compass information of the video collector. Examples of target information may include, but are not limited to, range of the target from the video collector, angle and orientation of the video collector, and field of view of the video collector.

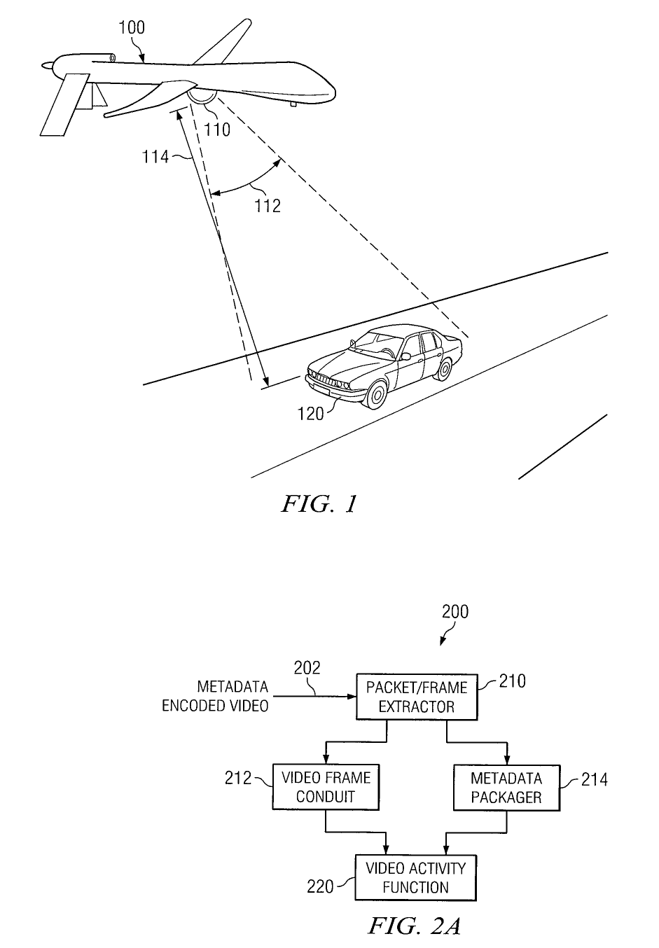

For example, FIG. 1 shows an unmanned aerial vehicle (UAV) 100 with video collection capabilities. UAV 100 features a video collector 110. In the illustrated example, the video collector 110 is capturing a target 120. The target 120 is within the video collector's field of view 112 and at a distance 114 from the video collector. In the illustrated example, the video collector 110 may record metadata. For example, the video collector 110 may record geo-positional information of the UAV 100, such as the latitude/longitude, altitude, and azimuth information. In addition, the video collector 110 may record other metadata such as target metadata, which may include the field of view 112 and the range 114. Alternative examples may include other metadata in addition to or in place of the provided examples.

FIG. 1 illustrates a video collector 110 that records overhead aerial video. However, embodiments of the video collector 110 may record video at any orientation. For example, in one embodiment, the video collector 110 may be a handheld video collector controlled by a soldier or pedestrian. Embodiments of the methods described herein may apply to video recorded at any orientation.

Teachings of certain embodiments recognize that embedded metadata may be used to extrapolate positional information about the video scene and targets captured within the video scene. For example, teachings of certain embodiments recognize that the metadata may be used to synchronize a video frame or a pixel within a video frame to a real-world position. In the example illustrated in FIG. 1, the target 120 may be represented by a plurality of pixels in a video frame. Teachings of certain embodiments recognize that one or more of these pixels may be mapped to the real-world position of the target 120 using metadata embedded in the video stream.

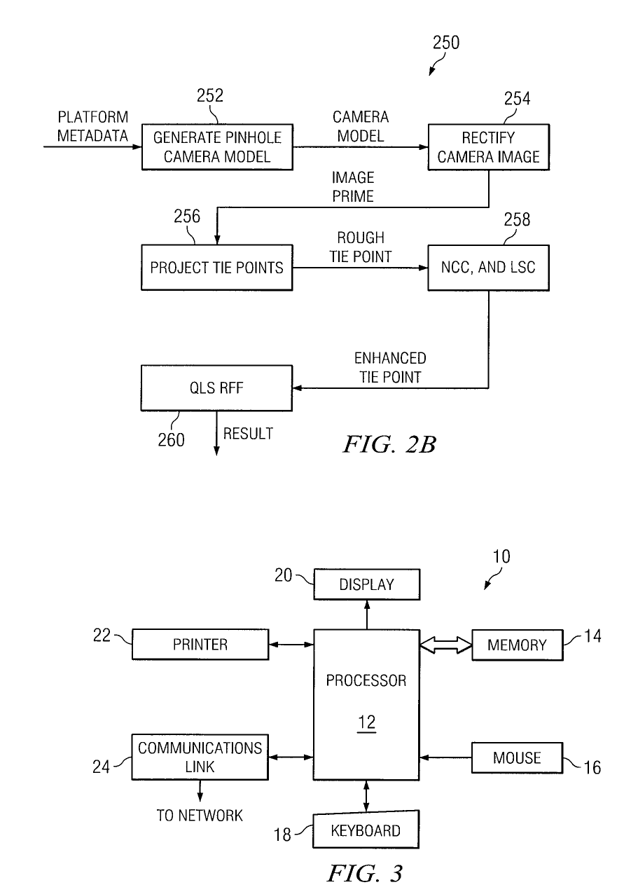

FIG. 2A shows one embodiment of a method 200 for processing a video with embedded metadata. According to the illustrated embodiment, the method 200 may begin by sending metadata encoded video 202 to a packet frame extractor 210. Metadata encoded video 202 may be a video stream comprising a plurality of encoded video frames. The video stream may be a previously recorded video or a live feed received in real-time. In some embodiments, the video stream may be provided in near-real time, in which streaming of the video feed may lag real-time by a latency period. In a few example embodiments, this latency period may last approximately a few seconds.

In some embodiments, the metadata of the metadata encoded video 202 may comprise embedded information like the time the video was taken, the location shown in the video, the camera type used to take the video, and/or any other suitable metadata, such as geo-positional or target metadata. The metadata may be encoded in any suitable format. For example, in some embodiments, the metadata may be encoded in keyhole markup language (KML) format or key-length-value (KLV) format.

In some embodiments, the method may iterate each time a video frame of the video stream is received. Thus, the synchronized image generated by the method may be continually updated to display the location shown in the current video frame. The user may use video features to obtain additional information about a video frame of interest. For example, a user may rewind the video, pause the video on a particular frame, or play the video in slow motion.

Upon receipt of a frame of the metadata encoded video 202, the packet frame extractor 210 may analyze the encoded video frame for specific byte combinations, such as metadata headers, that indicate the presence of metadata. When the packet frame extractor 210 detects metadata, it may perform an extraction function that separates the video frame and the raw metadata. The video frame may comprise the underlying video stripped of metadata. The metadata may be extracted from the video according to any suitable method. For example, extraction of metadata may be dependent on the type of video being processed and the type of collector from which it came. In some embodiments, separate streams may be sent to separate ports in a network, or separate streams may be wrapped within a transport stream and sent to multiple streams interwoven into the same program stream. At some point, the Motion Industry Standards Board (MISP) or other organization may create a standard for extracting metadata; however, to date delivery extraction methods are fairly wide ranging.

After performing the extraction function, the packet frame extractor 210 may send the video frame to a video frame conduit 212 to be displayed and/or to be passed to another function. In some embodiments, the packet frame extractor 210 may send the raw metadata to a metadata packager 214 to be formatted in a form that may be used by other programs.

According to some embodiments, the video frame conduit 212 may send the video frame to a video activity function 220. Upon receipt of the video frame, the video activity function 220 may request location information for the video frame from the metadata packager 214. The metadata packager 214 may reply to the request with location information based on the metadata corresponding to the video frame. This video activity function 220 may then format the video frame in a form that may be used by other programs. For example, in some embodiments, the video activity function 220 may forward the video frame to a user device that allows the user to access both the video frame and the location information corresponding to the frame. In one example embodiment, a user may roll a mouse curser over a video frame and retrieve the location information based on the metadata corresponding to the video frame or pixel. In another example embodiment, the video and location information are synchronized such that the video may be played while mapping the individual frames and/or pixels to location information. In yet another example embodiment, individual frames with corresponding location information could be used to set up searching capabilities on the videos themselves, such as searching a video for a particular location.

The metadata may be mapped to the video according to any suitable method. FIG. 2B shows one example of a method 250 for mapping pixels in a video frame to latitude/longitude information obtained from metadata. At step 252, platform metadata is received and a pinhole camera model is created. At step 254, the camera image is rectified. Rectification at step 254 may include placing the camera image in the pinhole camera model. At step 256, tie points are projected through the pinhole camera model to create a rough tie-point grid. At step 258, normalized cross correlation (NCC) and least-square coefficient (LSC) algorithms are applied to enhance the accuracy of the tie points. At step 260, quasi-linear solution (QLS) and rational function fit (RFF) algorithms are applied to produce rational position coefficients. These rational position coefficients may allow each pixel in a video frame to be mapped to a latitude and longitude.

Teachings of certain embodiments recognize that the video activity function 220 may provide video frames without orthorectification. Orthorectification refers to the process of scaling a photograph such that the scale is uniform: the photo has the same lack of distortion as a map. For example, in the embodiment illustrated in FIG. 1, the video collector 110 provides aerial video footage. In some circumstances, orthorectification may be necessary in order to measure true distances by adjusting for topographic relief, lens distortion, and camera tilt. However, teachings of certain embodiments recognize the capability to provide geo-location data without altering the photograph or video frame through orthorectification. However, embodiments are not limited to unaltered photographs or video frames; rather, teachings of certain embodiments recognize that photographs and video frames may still be altered through orthorectification or other processes.

FIG. 3 presents an embodiment of a general purpose computer 10 operable to perform one or more operations of various embodiments of the invention. The general purpose computer 10 may generally be adapted to execute any of the well-known OS2, UNIX, Mac-OS, Linux, and Windows Operating Systems or other operating systems. The general purpose computer 10 in this embodiment comprises a processor 12, a memory 14, a mouse 16, a keyboard 18, and input/output devices such as a display 20, a printer 22, and a communications link 24. In other embodiments, the general purpose computer 10 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 12, may manage the operation of the general purpose computer 10. Examples of the processor 12 include one or more microprocessors, one or more applications, and/or other logic. Certain logic may include a computer program, software, computer executable instructions, and/or instructions capable being executed by the general purpose computer 10. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 14. The memory 14 may comprise one or more tangible, computer-readable, and/or computer-executable storage medium. Examples of the memory 14 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 24 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

Although the illustrated embodiment provides one embodiment of a computer that may be used with other embodiments of the invention, such other embodiments may additionally utilize computers other than general purpose computers as well as general purpose computers without conventional operating systems. Additionally, embodiments of the invention may also employ multiple general purpose computers 10 or other computers networked together in a computer network. For example, multiple general purpose computers 10 or other computers may be networked through the Internet and/or in a client server network. Embodiments of the invention may also be used with a combination of separate computer networks each linked together by a private or a public network.

Although several embodiments have been illustrated and described in detail, it will be recognized that substitutions and alterations are possible without departing from the spirit and scope of the present invention, as defined by the appended claims. Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A method comprising:
receiving a data stream, the data stream comprising:
a video stream comprising one or more video frames captured by a video camera, each video frame presenting an image of a real-world scene, each video frame being comprised of a plurality of pixels; and
positional information of the video camera encoded in the video stream, the positional information of the camera comprising geo-positional information and target information, the target information describing the position of the real-world scene captured by the video camera in relation to the position of the video camera;
extracting the positional information of the video camera from the video stream; and
synchronizing the positional information of the video camera with the one or more video frames such that at least one or more of the plurality of pixels corresponds to a three-dimensional location in the real world at the real-world scene.

2. A method comprising:
receiving a data stream, the data stream comprising:
a video stream comprising one or more video frames captured by a video camera, each video frame presenting an image of a real-world scene; and
positional information of the video camera corresponding to the video stream;
extracting the positional information of the video camera from the data stream; and
synchronizing the positional information of the video camera with the one or more video frames such that a two-dimensional point on the image corresponds to a three-dimensional location in the real world at the real-world scene.

3. The method of claim 2, wherein each video frame is comprised of a plurality of pixels, the synchronizing the positional information with the one or more video frames further comprising:
synchronizing the positional information with at least one or more of the plurality of pixels.

4. The method of claim 2, wherein the positional information comprises geo-positional information.

5. The method of claim 2, wherein the positional information of the camera further comprises target information, the target information describing the position of the real-world scene captured by the video camera in relation to the position of the video camera.

6. The method of claim 2, wherein the positional information of the video camera is encoded as metadata in the video stream, the extracting the positional information of the video camera from the data stream further comprising extracting the metadata from the video stream.

7. The method of claim 2, further comprising:
streaming the one or more video frames to a user in real time.

8. The method of claim 2, further comprising:
streaming the one or more video frames to a user in near-real time.

9. The method of claim 2, further comprising iteratively resynchronizing the positional information for each video frame in the video stream.

10. The method of claim 2, the synchronizing the positional information with the one or more video frames further comprising:
creating a pinhole cameral model;
rectifying the video frame;
projecting tie points through the pinhole camera model; and
producing rational position coefficients that map each pixel in the video frame to a latitude and a longitude.

11. The method of claim 10, further comprising applying normalized-cross correlation and least-square coefficient algorithms to enhance the accuracy of the tie points.

12. The method of claim 10, wherein the producing rational position coefficients further comprises applying quasi-linear solution and rational function fit algorithms.

13. A system for extracting real world positional information from video, comprising:
a packet/frame extractor operable to:
receive a data stream, the data stream comprising a video stream, the video stream comprising one or more video frames captured by a video camera, each video frame presenting an image of a real-world scene, the data stream further comprising metadata representing positional information of the video camera corresponding to the video stream; and
extract the metadata from the data stream;
a video frame display operable to display the one or more video frames;
a metadata packager operable to repackage the metadata into a convenient format; and
a video activity controller operable to synchronize the positional information of the video camera with the one or more video frames such that a two-dimensional point on the image corresponds to a three-dimensional location in the real world at the real-world scene.

14. The system of claim 13, wherein each video frame is comprised of a plurality of pixels, the video activity controller further operable to synchronize the positional information with at least one or more of the plurality of pixels.

15. The system of claim 13, wherein the positional information comprises geo-positional information.

16. The system of claim 13, wherein the positional information comprises target information, the target information describing the position of a target captured by the video camera in relation to the position of the video camera.

17. The system of claim 13, wherein the positional information of the video camera is encoded in the video stream, the packet/frame extractor further operable to extract the metadata from the video stream.

18. The system of claim 13, the video activity controller further operable to stream the one or more video frames to a user in real time.

19. The system of claim 13, the video activity controller further operable to stream the one or more video frames to a user in near-real time.

20. The system of claim 13, the video activity controller further operable to resynchronize the positional information for each video frame in the video stream.

21. The system of claim 13, the video activity controller further operable to
create a pinhole cameral model;
rectify the video frame;
project tie points through the pinhole camera model; and
produce rational position coefficients that map each pixel in the video frame to a latitude and a longitude.

22. The system of claim 21, the video activity controller further operable to apply normalized-cross correlation and least-square coefficient algorithms to enhance the accuracy of the tie points.

23. The system of claim 21, wherein the video activity controller produces rational position coefficients by applying quasi-linear solution and rational function fit algorithms.
